(19) United States
(12) Patent Application Publication
(10) Pub. No.: US 2023/0240324 A1
(43) Pub. Date: Aug. 3, 2023

(54) MEAT ANALOGUE AND METHOD OF PRODUCING THE SAME

(71) Applicant: REDEFINE MEAT LTD., Rehovot (IL)

(72) Inventors: Daniel Dikovsky, Ariel (IL); Jonathan Hausner, Kefar Saba (IL)

(21) Appl. No.: 18/002,693

(22) PCT Filed: Oct. 14, 2021
(86) PCT No.: PCT/IL2021/051220

§ 371 Date: Dec. 21, 2022

(30) Foreign Application Priority Data
Oct. 14, 2020 (IL) 278052

(51) Int. Cl. A23J 3/22; A23J 3/14; A23J 3/26; A23P 20/20; A23L 29/256; B33Y 10/00; B33Y 70/00; B33Y 80/00

(52) U.S. Cl. CPC A23J 3/227; A23J 3/14; A23J 3/26; A23L 29/256; A23P 20/20; B33Y 10/00; B33Y 70/00; B33Y 80/00; A23P 2020/253

(57) ABSTRACT

The present disclosure provides an edible meat analogue and a method of producing the same, the meat analogue comprising a plurality of protein strands and inter- strand sheaths material, wherein in at least one sample of said edible meat analogue, the following conditions are fulfilled: (i) the plurality of protein strands are essentially aligned, (ii) at least a portion of the protein strands are at least partially surrounded by the inter-strand sheaths material; (iii) the inter-strand sheaths material comprises at least one component that has a melting point above 30° C.; and (iv) the inter-strand sheaths material forms a network interconnecting between at least two neighboring, spaced apart, protein strands; and wherein said inter-strand sheaths material is selected to provide at least one of the following physical properties: (a) an average hardness of a specimen of the meat analogue, of at least 46 N; and (b) an average tensile strength of at least 0.012 MPa of a specimen of the meat analogue.

### TECHNOLOGICAL FIELD

The present disclosure relates to the food industry and specifically to the meat analogue industry.

### BACKGROUND ART

References considered to be relevant as background to the presently disclosed subject matter are listed below:
U.S. Pat. No. 2,682,466
U.S. Pat. No. 2,730,447
U.S. Pat. No. 2,730,448
International Patent Application Publication No. WO2020/152689
International Patent Application Publication No. WO2020/030628
International Patent Application Publication No. WO2020/030628

Acknowledgement of the above references herein is not to be inferred as meaning that these are in any way relevant to the patentability of the presently disclosed subject matter.

### BACKGROUND

The development of Additive Manufacturing techniques has grown significantly in the food industry, and specifically, in the meat analogue industry.

Already back in the 1950′s the manufacturing of high protein artificial (synthetic) meat has been described in U.S. Pat. Nos. 2,682,466, 2,730,447 and 2,730,448 according to which a quantity of protein filaments/fibers are bound together using an edible binder.

Recently, Publication No. WO2020/152689A1 describes a meat analogue that comprises a protein-based component and a fat-based component separately distributed within the meat analogue; wherein the meat analogue comprises at least one segment that consists essentially of the protein based component which is chemically distinct from at least one other segment that consists essentially of the fat-based component; and wherein at least one of the following is fulfilled (i) a cubic sample of the meat analogue exhibits an anisotropic physical property and (ii) the meat analogue comprises a non-homogenous distribution of the protein based component and the fat-based component. Also disclosed herein is a method of producing the meat analogue, the method preferably involved digital printing of the meat analogue.

Further recently, Publication No. WO2020/030628 describes edible microextruded products, preferably meat replacers, with compressive and tensile Young’s moduli resembling the mechanical properties of meat, the edible products comprising several layers of microextruded elements made of a viscoelastic composition, the viscoelastic composition comprising in an appropriate edible solvent, high amounts of protein and an edible pseudoplastic polymer. The products are obtained particularly using a 3D printing method.

Yet further, WO2020/030628 describes a process for manufacturing of an edible microextruded product comprising two or more layers of viscoelastic microextruded elements, each extruded element comprising a protein, an edible pseudoplastic polymer and an appropriate edible solvent. Also described are edible composite products.

### GENERAL DESCRIPTION

The present disclosure provides, in accordance with a first of its aspects an edible product, preferably one mimicking meat, comprising a plurality of protein strands and a plurality of inter-strand sheath material;
wherein in at least one sample of said edible meat analogue, the following conditions are fulfilled:
   said plurality of protein strands are essentially aligned in said at least one sample,
   at least a portion of the protein strands are at least partially surrounded by the inter-strand sheaths material;
   said inter-strand sheaths material comprises at least one component that has a melting point above about 30° C.;
   said inter-strand sheaths material forms a network interconnecting between at least two neighboring, spaced apart, protein strands; and
wherein said inter-strand sheaths material is selected to provide said edible product at least one of the following physical properties:
   an average hardness of at least 46 N when measured from at least two directions perpendicular to the nominal direction of the protein strands in a specimen of said edible product; and
   an average tensile strength of at least 0.012 MPa when measured from at least two directions perpendicular to said nominal direction of the strands in a specimen of said edible product.

The present disclosure also provides an additive manufacturing method for producing a meat analogue, the method comprising:
(a) dispensing one or more strands of protein into at least one protein layer, each said protein layer comprising essentially aligned protein strands, at least a portion of said protein strands being spaced apart from its neighboring strand;
(b) over one or more protein layers, dispensing an inter-strand sheaths material; and
(c) repeating said steps (a) and (b) until reaching a desired dimension for said meat analogue;
wherein said sheaths material occupies spaces between neighboring strands.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B provide a 3D model of a meat analogue with an indication of the spatial dimensions including the XP axis (width), Z axis (height) and P axis (length), including that of meat analogue slab (FIG. 1A) and a meat analogue steak (FIG. 1B).

FIGS. 2A-2G are schematic cross sectional views (Z-XP plane) of several assembly planes for protein stands and sheath material according to some non-limiting configurations of the present disclosure, including a configuration where essentially all strands are spaced apart and interconnected using a flat sheath material (FIG. 2A); a configuration with alternating layers of paired strands (FIG. 2B); a configuration with each protein layer composed of two essentially aligned monolayers (FIG. 2C); a configuration on where each layer comprises monolayer of single or paired strands (FIG. 2D); a configuration with random gaps between strands (FIG. 2E); a configuration produced using an undulated sheath material and multilayers of protein material (FIG. 2F), and a configuration where each protein monolayer is separated by an undulated sheath material (FIG. 2G).

FIGS. 3A-3E are schematic illustrations of different configurations for the inter-strand sheath before placement over a layer of protein strands.

FIGS. 4A-4C are images of a multi-layered meat analogue including a side and top view after assembly (FIGS. 4A-4B), and side view after compressing the assembled layers (FIG. 4C).

FIGS. 5A-5B are images of a meat analogue obtained following a manufacturing process of a type illustrated in FIG. 2A; FIG. 5A providing an optical image while FIG. 5B providing the same image with a scale.

FIGS. 6A-6B are two images of a gripping element of a system constructed for conducting tensile tests, FIG. 6B showing the inner roughened surface of the grippers, allowing for the retention of the meat analogue by the grippers; while FIG. 6A showing the meat analogue held by the grippers.

FIGS. 7A-7C are tensile strength measurements along P axis (FIG. 7A), XP axis (FIG. 7B) and Z axis (FIG. 7C).

FIG. 8 is a graph showing the results of FIGS. 7A-7C.

FIGS. 9A-9B are images comparing a meat analogue sample comprising carrageenan and gluten (Car-Glu, FIG. 9A) vis-à-vis true meat (FIG. 9B).

FIGS. 10A-10C provide an illustration of tensile strength measurement elements including a T-shaped fixture element (FIG. 10A) including an arm and a plate; and a pair of T-shaped fixtures sandwiching a test specimen (FIG. 10B); and an image of a tensile strength measurement system in operation (FIG. 10C).

### DETAILED DESCRIPTION OF EMBODIMENTS

The present disclosure is based on the understanding that connective tissue and more specifically the perimysium plays an important part in the physical and organoleptic properties of beef meat. Thus, it has been envisaged that in order to improve the quality of meat analogues it is important to specifically incorporate within any meat analogue a component that mimics the functionality of at least the perimysium, i.e. that can hold together the fibrous component of the meat analogue.

Based on the above understanding, an improved meat analogue and methods of obtaining the same have been developed.

Specifically, as disclosed herein, there is provided an edible meat analogue comprising a plurality of protein strands and a plurality inter-strand sheaths material. The plurality of protein strands in the meat analogue are essentially aligned along a longitudinal axis of said meat analogue, at least a portion of the strands being spaced apart from a neighboring strand; with at least a portion of the protein strands being at least partially surrounded by inter-strand sheaths material; the inter-strand sheaths material comprising at least one component that has a melting point above 30° C.; and the inter-strand sheaths material forming a network interconnecting between at least two neighboring, spaced apart, protein strands. The inter-strand sheaths material is selected to provide the edible meat analogue with at least one of the following physical properties:
an average hardness of at least 46 N when measured from at least two directions perpendicular to the nominal direction of the protein strands in at least one specimen of the meat analogue; and
an average tensile strength of at least 0.012 MPa when measured from at least two directions perpendicular to said nominal direction of the strands in at least one specimen of the meat analogue.

In the context of the present disclosure, when referring to a specimen or sample of the meat analogue product it is to be understood to encompass the entire product as well as at least one cut allowing the visualization of the alignment of the strands. In some examples, the specimen is a sample having dimensions of about 1 cm*1 cm*1 cm. The specimen needs not to be cubic in shape, and can have any configuration, as long as it includes at least two layers of the aligned strands.

A unique feature of the meat analogues provided herein is that they resemble or are aimed at resembling real meat products in terms of taste, texture, consumer experience and other properties as typically examined by those versed in the art. Without being bound by theory, it is believed that good mimicking of true meat was achieved due to the addition of the inter-strand sheaths material.

In some examples, when referring to a meat analogue it is to be understood as encompassing an essentially (and preferably exclusively) animal free meat products that are obtained using additive manufacturing techniques, also known by the term 3D printing.

In some examples, the additive manufacturing technique includes digital printing.

As appreciated by those versed in the art of additive manufacturing, the process is used to create a physical (or 3D) object by layering materials one by one, typically based on a digital model.

The edible meat analogue disclosed herein comprises layers. Each layer comprises two or more, essentially aligned strands of protein and the combination of layers, stacked one on top of the other, comprise said plurality of protein strands.

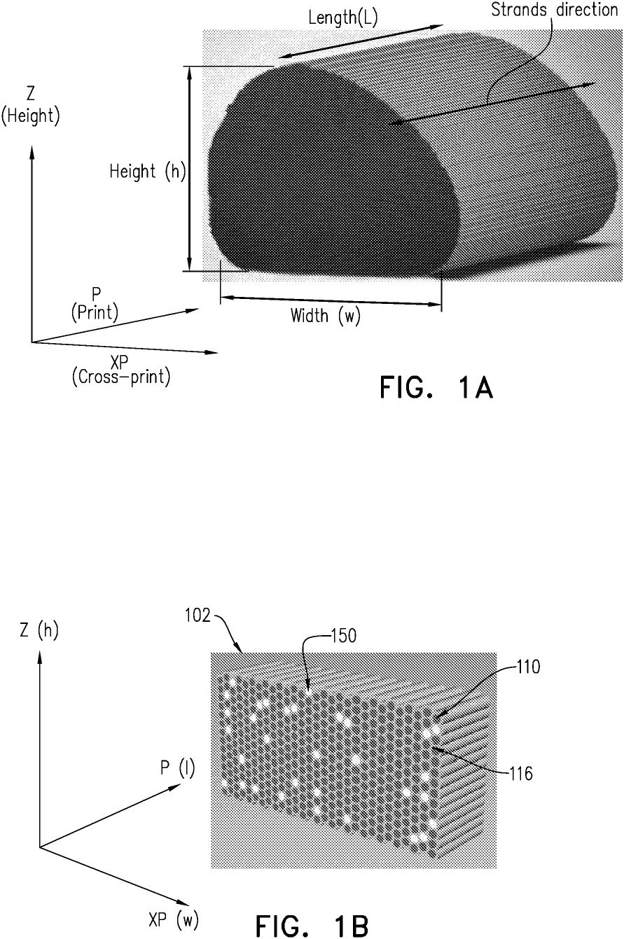

The alignment of the protein strands is illustrated in FIG. 1A (slab illustration) and FIG. 1B (steak illustration/steak segment). FIG. 1A illustrates the directions of the strands with respect to a Cartesian coordinate system, with the essential alignment of the strands being essentially parallel to the P axis. FIG. 1B illustrates directions of strands within a steak 102 in accordance with the present disclosure, with protein strands 110 essentially parallel and aligned with the P axis. FIG. 1B also illustrates intermittently, some fat material 150 in between protein strands 110. Also illustrated is the sheath material 116 inter-connecting the strands. Notably, FIG. 1B illustrates a steak cut along the XP axis of a slab, such as shown in FIG. 1B. However, a steak can also be cut from a slab along any other line, irrespective of the direction of printing the slab.

In the context of the present disclosure, when referring to “protein strand(s)” it is to be understood as referring to a composition comprising one or more edible proteins, having a shape of a strand or a rod and that can be deposited on a printing bed while maintaining the shape of a strand. This can be achieved by combining into the protein composition substances that assist in maintaining the shape of the composition (e.g. by the use of hydrogels) and/or by exposing the composition to curing actions, etc., as known in the art.

The protein composition can include other components.

In some examples, the protein strand comprises a protein composition comprising at least 10%w/w, at times, at least 20%w/w, at times, at least 30%w/w protein(s).

In some examples, the protein strand comprises at least 50%w/w water.

In some examples, the protein strand comprises texturized protein.

In this context, when referring to a texturized protein matter it is to be understood as defining the physical state of the protein within the texturized protein strand. In some examples the protein matter is comprised of protein molecules bound to water that are texturized to create a fibrous structure. In other examples, the texturized protein comprises protein molecules that are substantially aligned in a certain direction as to create a substantially aligned fibrous structure. The alignment of the protein material can be achieved, for example, by cooking extrusion processes, shear (Couette) cell and/or spinning all well known in the art, as well as by cold extrusion in which pre-existing bundles of proteinous fibers in a dough are forced through a narrow passage in order to align them with respect to the extrusion direction. Further or alternatively, when referring to texturized protein strands it is to be understood to mean that the strand comprises one or more bundles of texturized fibers, e.g. essentially axially aligned protein containing fibers; and that each bundle of texturized fibers comprises a structurally organized collection of protein material.

In some examples, the protein material comprises denatured protein. Denatured protein can be of the kind obtained by methods known in the art, that would lead to protein denaturation and / or protein filament alignment and creation of fibrous configurations. Without being limited thereto, the denatured proteins can be of a kind obtained by applying mechanical forces (e.g. in processes such as: spinning, agitating, shaking, shearing, pressure, application of turbulence, impingement, confluence, beating, friction, wave), radiation (e.g. microwave, electromagnetic), thermal energy (heating - by steam or otherwise), cross-linking, enzymatic reaction (e.g. transglutaminase activity) and chemical reagents (e.g. pH adjusting agents, kosmotropic salts, chaotropic salts, gypsum, surfactants, emulsifiers, fatty acids, amino acids).

It is to be noted that the meat analogue disclosed herein can contain the same protein material/composition in the entire product, yet, in some examples, the meat analogue can contain a combination of different types of protein, i.e. different types of protein strands. The difference in the protein strands within a single meat analogue product can be exhibited by any one of the following
difference in the composition of the components forming the strand, e.g. in the types and or degree of purity of proteins included within the different strands and/or in the amounts of proteins included within the different strands (even if the same proteins are used among the different protein strands in a single meat analogue product),
difference in the water concentration, fat concentration and/or different types and/or concentrations of food additives known in the food industry (such as flavor materials, coloring agents)
difference in the texture of the protein such that for example, some strands within a meat analogue product can be highly texturized (preferably fibrous, preferably substantially aligned fibrous) and some less texturized, and some untexturized, so they exhibit different textural behavior.
difference in the form of the strands such that some strands within a product are in the form of a gel and some others, within the same product, can be in the form of a dough and/or an emulsion.

In some examples, at least some of the protein strands are in a form of a dough (e.g. thick malleable paste).

In some other examples, at least some of the protein strands are in a form of a gel.

In some other examples, at least some of the protein strands are in a form of an emulsion.

The amount of protein in the protein strand may vary depending, inter alia, on the type of proteins, desired physical (e.g. textural) properties, other substances with which they are combined etc. Yet, in some examples, the protein strands comprise between 5 w% to 80 w%, at times between 10 w% to 60 w% (wet base) protein material. In some other examples, the protein strand comprises at least 10% protein, at times, at least 20%, at least 30%, at least 40%, at least 50%, at least 60%, at times at least 70% protein material. The rest (non-protein matter) being one or combination of fat, carbohydrates and mostly water or an aqueous based media.

The amount of protein can be determined by techniques known in the art. For example, by the Kjeldahl method using a specific Jones factor.

In the context of the present disclosure, when referring to a protein composition or to protein material it is to be understood to refer to the composition making up the protein strand. The protein composition typically comprising water and edible protein material. The protein material can include a single type or a combination of proteins, peptides, oligopeptides and amino acids.

In some examples, the protein composition is free of fat.

In some other examples, the protein composition comprises fat, e.g. to modulate the rheological properties of the protein strand, e.g. flexibility of the protein material.

In some examples, the protein strands comprise one or more proteins in combination with other non-protein material, including water and fat, the water component and fat component being further discussed below.

The protein(s) can be of any source that is acceptable and safe for human use or consumption.

In some examples, the protein(s) are of a non-mammal source. A non-mammal source can include, without being limited thereto, plant source, arthropods (e.g. insects), algae, fungus (e.g. yeast), bacteria or another microorganism.

In some other examples, the protein(s) are of a non-animal source. A non-animal source includes plant source as well as protein material obtained from cell culture, even if the cell is an animal cell.

In some examples, the protein(s) comprise plant proteins. The plant proteins can be in the form of a pure protein, a protein isolate, protein concentrate, protein flour, texturized protein such as texturized vegetable protein (TVP).

In the context of the present disclosure, TVP is used to denote both dry form of texturized vegetable protein (sometimes regarded to as expanded TVP), as well as high moisture form, known in the art as the outcome of high moisture extrusion (HME) or high moisture extrusion cooking (HMEC) or similarly. TVP may also denote any “intermediate” form of texturized vegetable protein, in which the moisture level in the TVP and/or the degree of expansion of the TVP is intermediate between those typically found in dry (expanded) form and HME(C) form.

The protein(s) can be of any plant source, this includes, without being limited thereto, wheat, legume (pulses, beans, peas, lentils, nuts), plant seeds and grains (e.g. sunflower, canola, rice), stem or tuber protein (e.g. potato protein).

In some examples, the protein is derived from legume. Specific, yet non-limiting examples of legume/bean proteins include, soy protein, pea protein, chickpea protein, lupine protein, mung-bean protein, kidney bean protein, black bean protein, alfalfa protein.

Some specific, yet not limiting, proteins suitable for meat alternatives as disclosed herein are beta-gonglycinin, glycinin, vicilin, legumin, albumins, globulins, glutelins, gluten, gliadins, glutenins, mycoproteins.

As noted above, the protein material forming the strand can include a single type of protein or a blend of proteins. One example of a protein to be used as a single protein or in combination with other proteins is gluten. Without being bound by theory, such gluten-based fibers may be aligned into a certain direction by pulling or pushing through a printing nozzle.

One other example of a protein that can be used as a sole protein in the strands or in combination with other proteins is beta-conglycinin soy protein (isolate or concentrate).

In yet another example, at least part of the protein strands contains animal derived components, e.g. beef muscle, chicken muscle, egg protein, milk protein, insect-based protein, etc., or achieved by means of cell culturing techniques, even if the source is from animal.

In yet another example, at least part of the protein material contains recombinant proteins, derived from e.g. plants, algae, fungi, or microorganisms.

The protein material can include edible additives, such as, without being limited thereto, fibers originating from either protein and/or carbohydrate origin, including without limitation starches and dietary nutritional fibers (and other forms of cellulose-based fibers); colorants (e.g. annatto extract, caramel, elderberry extract, lycopene, paprika, turmeric, spirulina extract, carotenoids, chlorophyllin, anthocyanins, and betanin), emulsifiers, acidulants (e.g. vinegar, lactic acid, citric acid, tartaric acid malic acid, and fumaric acid), flavoring agents or flavoring enhancing agents (e.g. monosodium glutamate), antioxidants (e.g. ascorbic acid, rosemary extract, aspalathin, quercetin, and various tocopherols), dietary fortifying agents (e.g. amino acids, vitamins and minerals), preservatives, stabilizers, sweeteners, gelling agents, thickeners and dietary fibers (e.g. fibers originating from citrus source).

The protein strands may be coated with functional material. Coating can be partial coating such that portions of the outer surface of the strands are covered by the functional material, or coating can be complete coating, where the entire outer surface of the strands are covered with the functional material.

In the context of the present disclosure, the term “functional material” encompasses any substance bestowing a physical and/or chemical property to the strand. The functional material can be in a form of a powder, a film or a liquid associated with one or more portions of the outer surface of said one or more strands.

In some examples, the functional material can be one or more substances selected to improve texture of the strand. In one example, the functional material is selected to improve flexibility of the strand. Without being limited thereto, such substances can include water, a gelling agent (e.g. polysaccharides), an adhesive material, and further, as non-limiting examples, oil or at times, as non-limiting examples starch, alginate, wax, cellulose, non-edible, yet food safe poly-ethylene, poly-propylene, nylon or other types of film membrane/food packaging materials. In the case of non-edible coating, these would typically be removed before printing.

In yet some other examples, the functional material is one that protects the fibrous material from oxidation, e.g. when the texturized protein is hydrated or even partially hydrated and therefore more prone to oxidative damage. Without being limited thereto, such anti-oxidative coating material can include food safe polymers.

In yet some other examples, the functional material is a bacterial protectant, namely, prevents/blocks bacterial growth on the strands, e.g. when the texturized protein is hydrated or even partially hydrated and therefore more prone to bacterial contamination.

In some examples, the functional material is a hydrating/moisturizing material, used to moisture or increase water content at least at the surface of the strand. Without being limited thereto, such moisturizing material is or comprise water.

In some other examples, the functional material can be one or more substances selected to strengthen the strands. Without being limited thereto, such substances can include cellulose based, such as methylcellulose (e.g. in the form of powder), crystalline methylcellulose (CMC), alginate, pectin; anti-caking agents; Zein powder; edible mineral powder, hydrocolloids as well as non-edible, yet food safe poly-ethylene, poly-propylene, nylon or other types of film membrane/food packaging materials. In the case of non-edible coating, these would typically be removed before printing.

In some examples, the functional material is an edible additive material (some being defined above) that remains associated with the strand and forms part of the final food product.

In some examples, the functional material is an adhesive precursor, namely, a material that can be activated to act as an adhesive, e.g. when hydrated/brought into contact with water. For example, such functional material can comprise starch and/or gluten that once wetted, becomes sticky and acts as an adhesive.

The functional material can be associated with the protein strands by any one of spraying, powdering, immersing, the strand with the functional material.

The protein strand can be defined by its length and width. In the context of the present disclosure, the length defines the dimension along the longitudinal axis of the strand, and the width defines the dimensions of the axes perpendicular to the longitudinal axis (the cross-section dimensions).

Accordingly, when referring to a strand, it is to be understood as encompassing short, medium length and elongated strands; short strands having a length within the range of about 10 mm and about 50 mm, a medium strand having a length within the range of about 50 mm and about 100 mm and an elongated strand having a minimal length of about 10 cm at times between about 10 cm and meters or even tens of meters.

The strand can also be defined by its cross-section width (e.g. diameter, when the strand has a circular cross section, or diagonal, when the strand has a polygonal cross section).

In some examples, the strand is characterized by a width within the range of between about 0.1 mm and about 10 mm, at times about 0.5 mm and about 10 mm, at times, between about 0.1 mm and about 5 mm, at times, between about 1 mm and about 5 mm, at times, between about 0.5 mm and about 3 mm, at times, between about 0.5 mm and about 2 mm, at times, between about 2 mm and about 4 mm, at times between about 1 mm and about 5 mm.

The strand can, alternatively, or in addition, be defined by a two-dimension ratio, e.g. length to average cross section ratio, e.g. about 500 mm strand of about 2 mm diameter would have dimension ratio of about 250.

In some examples, the strand has a curved (e.g. elliptic, circular) or polygonal (e.g. triangle, square, pentagonal or hexagonal) circumference.

In some examples, the strand has an amorphic circumference, i.e. with no defined cross-sectional geometry.

The strands can be obtained by various techniques.

In some examples, the strands are obtained by extrusion.

In some examples, the strands are obtained by using shear cell.

In some other examples, the strands are obtained by mechanical slicing of strands.

As noted above, the strands are essentially parallel or essentially aligned to have a nominal direction.

In the context of the present disclosure, the term “essentially” is used to denote some level of deviation, such as 1%, 2%, 3%, 10%, or even up to 20%, from a defined parameter.

In this context, when referring to “essentially parallel strands” or “parallelly oriented strands” or “essentially aligned” it is to be understood to refer to the orientation of at least 80% of the strands (and/or the fibers within a texturized protein strand), preferably 95% of the strands (and/or fibers) and preferably 99% of the strands (and/or fibers), one with respect to the other when viewed within a specimen, to be generally parallel. In this context, the essential alignment is within a specimen having a dimension of at least 1 cm*1 cm*1 cm.

The term “essentially parallel” or “generally parallel” should be understood to encompass the nominal direction of the longitudinal axis to be at most ± 10°, at times, at most ± 3°, at most ±1°.

The term “nominal direction” as used herein refers to a direction where significantly more than 50% of the strands and/or of the fibers within the strand have a direction of up-to ±45 degrees from that nominal direction, when the strand is viewed from any direction perpendicular to the strand direction. The term “nominal direction” may also refer to the average of the strands’ or fibers’ direction as found using high magnification imaging as described herein. The nominal direction is a solid angle, where its projection on each of the 2 views, is the average direction found at this view.

When the protein is a texturized protein material, each protein strand typically contains essentially axially aligned fibers. The fibers within a strand can be arranged as a single or a plurality of distinct bundles.

In accordance with some examples the protein fibers within the strands are elongated fibers.

The term “essentially axially aligned fibers” as used herein refers to a fibrous protein strand which comprises fibers having a nominal direction that is essentially to the same as that of the direction of the strand’s elongated axis.

The alignment in the fibrous material within a strand can be obtained by various techniques. For example, by applying constant mechanical forces in a certain direction on a flowing protein material either by continuous pushing (e.g. as done during extrusion), continuous pulling (e.g. as done in spinning) and shearing (e.g. as done in a shear Couette cell). The alignment techniques of the fibrous material may utilize thermal effects (e.g. heating or cooling), chemical agents (e.g. enzymes) etc., for enhancing the anisotropic character of the resulting fibers.

In some examples, the alignment of the protein material within a strand is obtained by extrusion, such as hot extrusion or cold extrusion. Accordingly, the one or more texturized protein strands comprise protein extrudate.

In some other examples, the alignment of the protein material within a strand is obtained by spinning, e.g. carried out using an electrospinning device. There are different approaches in spinning of proteins so as to texturize them, including, without being limited thereto, an enzymatic approach (typically to yield a gel like structure), a dehydration approach (typically to rigidify the protein material); a temperature approach (to affect flowability/solubility of the protein material); an anti-diluent approach (typically referred to as a wet spinning); pH approach (typically also to affect solubility of the protein material, for example, chitosan which is more soluble at weak acidic conditions).

In some examples, in order to facilitate the formation of essentially aligned protein material, the latter can be combined with one or more polysaccharides. Without being limited thereto, such polysaccharides are water soluble or polymers that are soluble at specific pH. Such polymers include, without being limited thereto, Guam gum, Xanthan gum, k-Carrageenan, chitosan, cellulose, starch and lignin.

The meat analogue can comprise additional materials, and not only the protein material and the inter-strand sheath forming material.

In some examples, the meat analogue comprises fat material. In the context of the present disclosure, when referring to a fat material it is to be understood as a composition of matter comprising lipophilic material.

The term lipophilic material should be understood to encompass a single type or combination of lipophilic compounds that is acceptable and safe for human use or consumption. In the context of the present disclosure the lipophilic material can include, without limiting to, any one or combination of fatty acids, fatty alcohols, oils, lipids, butter and fats in general.

In some examples, the lipophilic material comprises one or more lipophilic compounds.

In some examples, the lipophilic material is of a non-mammal source. A non-mammal source can include, without being limited thereto, synthetic or semi-synthetic lipophilic compounds, plant source.

In some examples, the lipophilic material comprise plant derived lipophilic compounds.

In some examples, the lipophilic material comprises at least one oil, specifically, plant derived oil. A non-limiting list of plant derived oils include corn oil, olive oil, soy oil, peanut oil, walnut oil, almond oil, sesame oil, cottonseed oil, rapeseed oil, canola oil, safflower oil, sunflower oil, flax seed oil, algal oil, palm oil, palm kernel oil, coconut oil, babassu oil, wheat germ oil, and rice bran oil.

In some examples, the lipophilic material comprises at least butter. A non-limiting list of edible butters that can be employed within the lipophilic material include shea butter, mango butter, cocoa butter and kukum butter.

In some examples, the lipophilic material comprises at least one fatty acid (saturated and unsaturated). In some examples, the fatty acid is a C6-C24 saturated or unsaturated fatty acid.

In some examples, the lipophilic material comprises fat material, such as, without being limited thereto, glycerides (monoglycerides, diglycerides, triglycerides). A specific, yet non-limiting example of a triglyceride is lecithin or lysolecithin.

In some examples, the lipophilic material is one derived from algae, fungi or microorganism (e.g. archaea), either recombinantly or not.

In some examples, the lipophilic material is derived from animal source, or contains products derived recombinantly that are identical to animal-based materials. Without being limited thereto, the lipophilic material can be derived directly from animal or extracted from animal cell culture. Examples include, without being limited thereto, pig fat (lard), bovine fat, chicken fat, duck fat.

In some examples, the lipophilic material can contain fat-substitutes, so as to reduce the calories of the resulting product. Fat substitutes are known in the art and can be divided into four categories, carbohydrate based (e.g. cellulose, dextrins, modified starches, fruit based fibre, grain based fibre, hydrocolloid gums, maltodextrin, pectin), protein based (e.g. microparticulate protein, modified whey protein concentrate), fat based (e.g. altered triglycerides, sucrose polyesters, esterified propoxylated glycerol) and combinations of same [Position of the American Dietetic Association: “Fat replacers”. Journal of the American Dietetic Association. 105 (2): 266-275. 2005, the content of which is incorporated herein by reference].

In some examples, the lipophilic material has a viscosity at 30° C. of between 3,000 and 1,000,000 centipoise (cP), at times, between 10,000 and 300,000 centipoise.

In some examples, the lipophilic material has a melting point temperature in the range of 30° C. to 80° C.

In some examples, the lipophilic material comprises an oleogel or organogel. Oleogels can be defined as semisolid systems, with a continuous phase made of a hydrophobic liquid (like a vegetable oil) where a self-assembled network (composed by the structurant) is responsible for the physical entrapment of the liquid. According to the desired physical characteristics and the food type application, oleogels with different properties may be produced. The structural conformation is dependent on the type of structurant used, which will dictate the desired final application of the oleogels [Martins, A. J., Vicente, A. A., Cunha, R. L., & Cerqueira, M. A. (2018). Edible oleogels: an opportunity for fat replacement in foods. Food & Function, 9(2), 758-773. Doi:10.1039/c7fo01641g, the content of which is incorporated herein by reference].

A non-limiting list of structurants used in edible oleogels comprise ethyl cellulose (EC), natural waxes (plant and animal) and natural resins, phytosterols and oryzanol, fatty acid derivatives, and lecithin.

The meat analogue typically also comprises a water-based or aqueous-based or moisture-providing material. The water-based material comprises water solutions or water-based gels carrying various solutes and/or suspended/dispersed material such as colorants, salts, thickening agents, fillers, stabilizers, emulsifiers, etc.

In some examples, the water-based material is in a form of a gel at temperatures in the range of 15° C. to 80° C., at times, in the range of 20° C. to 65° C.

In some examples, the water-based component comprises any one or combination of edible additives, such as colorants, emulsifiers, stabilizers, acidulants, flavoring agents, thickening agents, antioxidants, dietary fortifying agents, preservatives, vitamins, sweeteners, all known to those versed in the art.

The essentially aligned strands are also arranged to have a space between neighboring strands. In the context of the present disclosure, such space exists between at least a portion of the strands, i.e. some strands are in contact and some are spaced apart. These spaces (gaps) have a dimension ranging from several microns to several mm and within a layer the gaps do not necessarily have the same dimension, i.e. gaps can vary in their dimension within a layer, within a monolayer and/or between monolayers and/or layers.

In some examples, the gaps between two spaced apart strands are within a range of between about 50 µm and about 5 mm.

In some examples, the gap between two spaced apart strands is within any range within the range of about 50 µm and about 5 mm; this includes, for example, about 50 µm and about 1 mm or about 100 µm and about 5 mm, or about 150 µm and about 5 mm or about 100 µm and about 1 mm or about 50 µm and about 500 mm or about 50 µm and about 2.5 mm or about 100 µm and about 2.5 mm or about 50 µm and about 250 mm.

The essentially parallel strands are in contact with inter-strand sheath material. As exhibited by the non-limiting examples provided herein, at least a portion of the protein strands are surrounded by inter-strand sheath forming material. In other words, some of the strands are at least partially enveloped by the inter-strand sheath forming material. This means that some strands can be completely enveloped, some strands at least partially enveloped, and some strands entirely un-enveloped by (in no contact with) the sheath forming material.

Further, as further exhibited by the non-limiting examples provided herein, the inter-strand sheaths form a network-like structure interconnecting between at least two neighboring, spaced apart, proteins.

In the context of the present disclosure, the term “inter-strand sheaths” it used to denote the mass (material) that envelops, at least partially, the strands, the composition of the mass being different from the protein composition forming the strands. The thickness of the inter-strand sheaths can be dictated by the distance between the strands. In some examples, the inter-strand sheaths are designed such to have, before placement onto the protein layers, a thickness of at least about 0.05 mm; at times, of at least about 0.6 mm; at times, of at least about 0.7 mm; at times, of at least about 0.8 mm; at times, of at least about 0.9 mm; at times of at least about 0.1 mm. In some examples, the inter-strand sheaths are designed such to have, before placement onto the protein layers, a thickness of between about 0.05 mm and about 5 mm; at times, between about 0.1 mm and about 5 mm, at times, between about 0.05 mm and about 2 mm; at times, between about 0.1 mm and about 2 mm; at times between about 0.05 mm and about 1 mm, at times between about 0.1 mm and about 3 mm. Needless to state, within the end product, the thickness of the inter-strand sheath may be below the recited dimensions, inter alia, due to the compression step taken place during the production of the product.

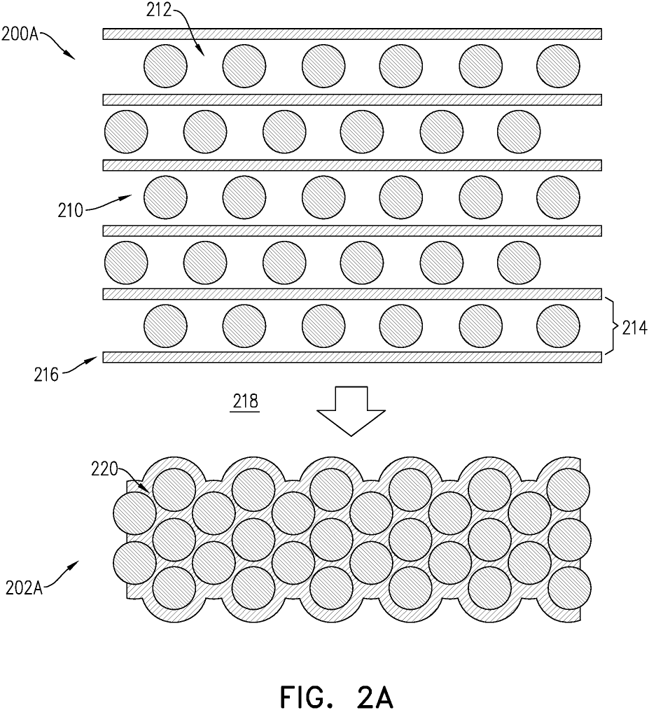

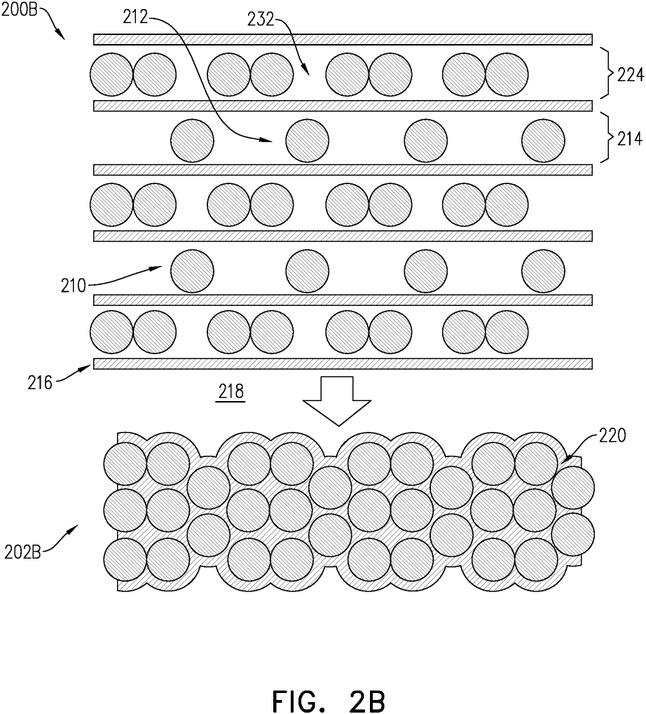

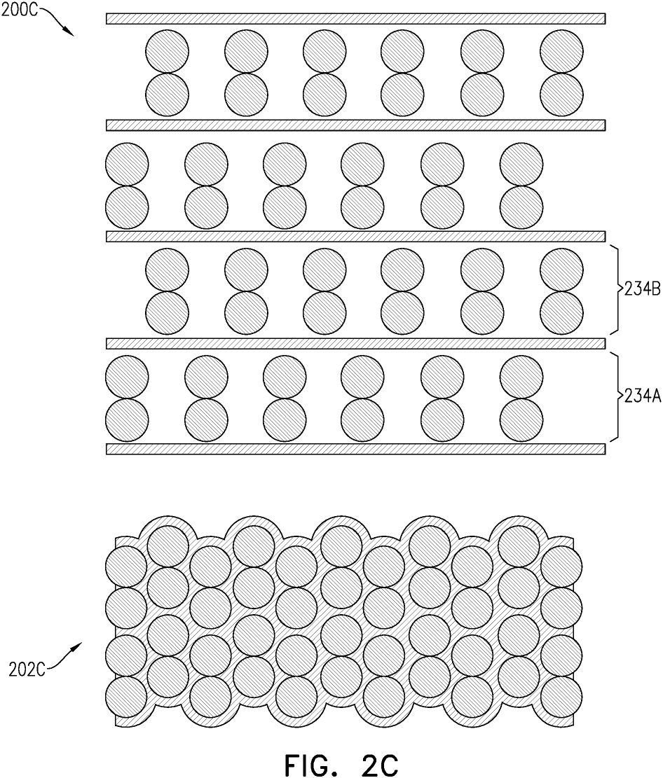

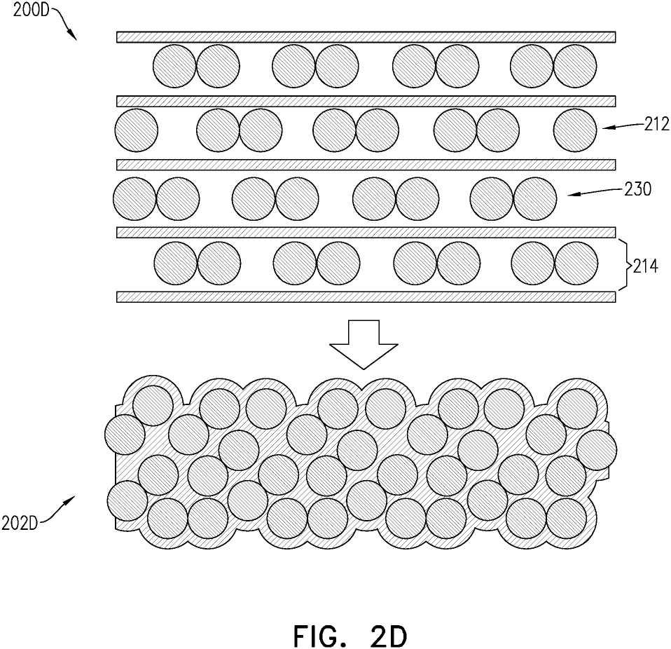

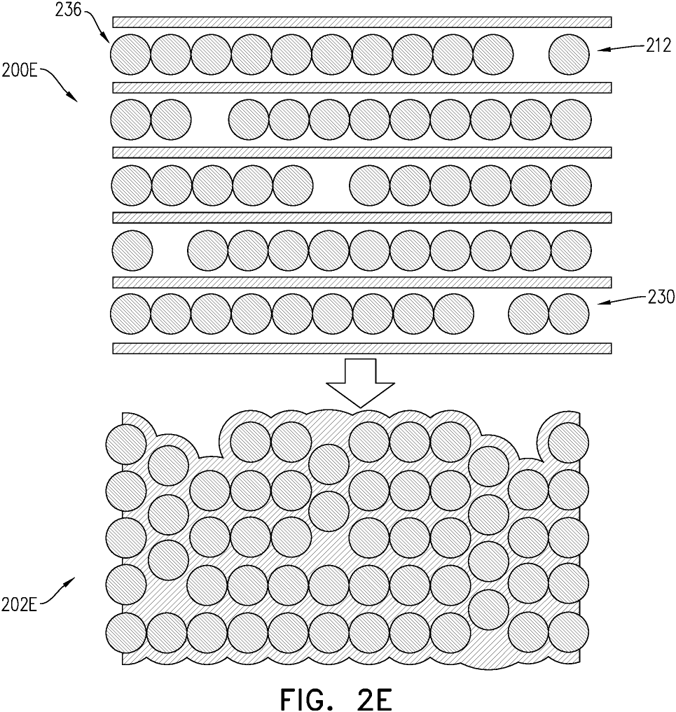

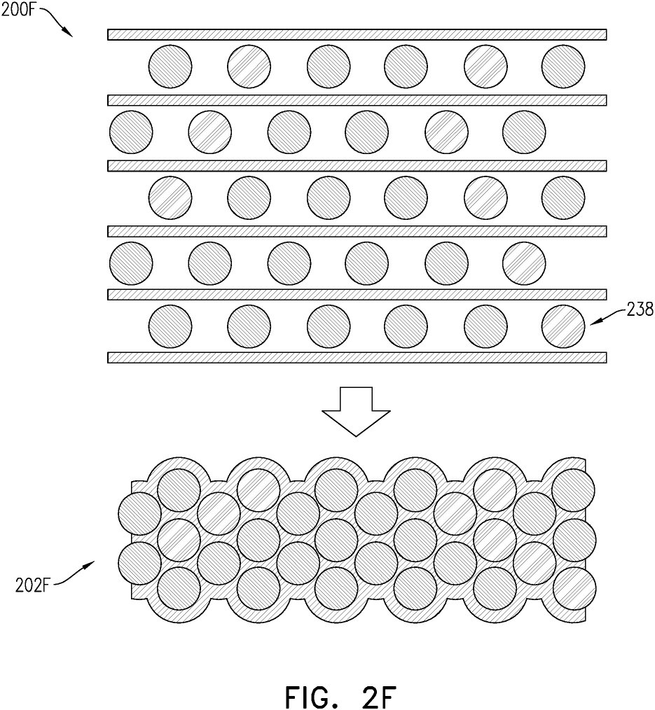

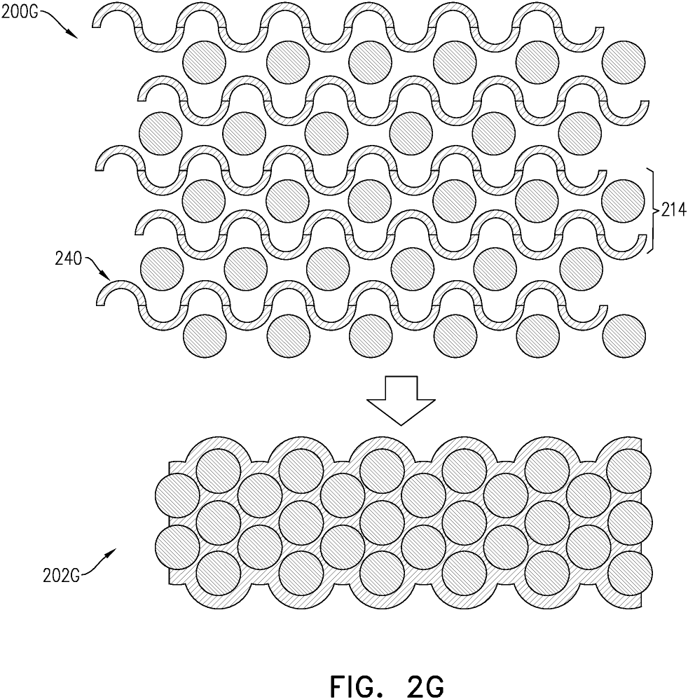

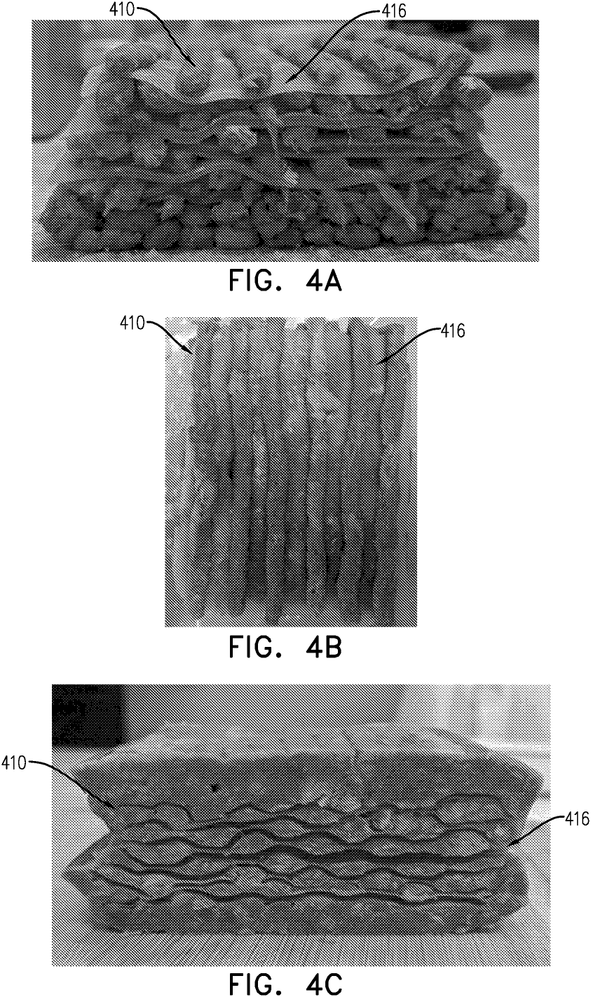

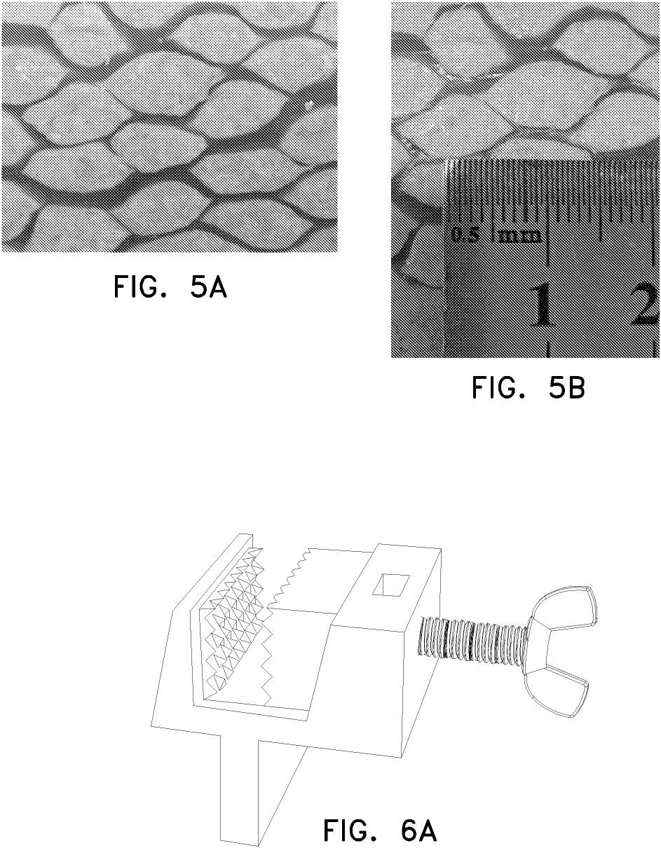

In the context of the present disclosure, the term “network” is used to define the appearance of the sheath material when a cross section of the meat analogue is taken, resembling a network, a web or a scaffold holding within the “voids” of the web the protein/strand(s) material. Each “void” of the network/web can be occupied by one or more strand(s) as illustrated in the non-limiting examples of FIGS. 2A-2G, FIGS. 4A- 4C and FIGS. 5A-5B.

In some examples, the network and the strands are arranged in a manner providing a honey-comb-like appearance when a cross section of the meat analogue is taken from a direction perpendicular to the nominal direction of the strands. Other non-limiting examples of possible appearances of the network are provided in FIGS. 2A-2G.

A unique feature of the present disclosure resided is the fact that at least a portion of strands of one layer fit into spaces between layers of a previously applied protein layer. This allows the formation of the honeycomb like appearance. The occupying of spaces between at least some of the protein strands in a protein layer by protein strands from the sandwiching protein layers has been found to improve the physical properties of the resulting meat analogue (i.e. to better resemble the organoleptic properties of true meat), as compared to layering of protein strands having no such dedicated spaces therebetween.

The inter-strand sheaths material envelops the strands. Yet not necessarily all strands are enveloped by the sheaths forming material. To withhold the strands together, it is designed such that at least 50% of the overall circumference of the strands are enveloped by the sheaths forming material. This can be determined from any randomly taken cross-section view of the meat analogue and determining therefrom the % volume occupied by the sheaths forming material (the cross-sectional slice taken perpendicular to the nominal direction of the strands therein).

It is to be noted that according to the present disclosure, it is not necessary that a strand being enveloped by the inter-strand forming material is 100% surrounded by the latter. In fact, it may be sufficient that at least 50%, at least 60%, or at least 70% of an enveloped strand is surrounded by the sheaths forming material, and the rest being essentially in direct contact with its neighboring strand. Yet, in a preferred example, at least 70% of an enveloped strand is surrounded by the sheaths forming material.

The material forming the inter-strand sheaths comprises at least one component being solid at room temperature, i.e. having a melting point above about 30° C., at times, above about 40° C. or even, at times, above 50° C. The inclusion of at least one component with an elevated melting point above room temperature, and preferably above 30° C. allows for the meat analogue to retain its integrity, inter alia, acting somewhat like a scaffold, holding the strands together.

In some examples, the inter-strand sheaths material comprises at least one component having a melting point between about 30° C. and about 70° C. or about 30° C. and about 100° C., i.e. being solid at room temperature.

In some examples, the inter-strand sheaths material comprises at least one component having a melting point of at least 50° C.; or between about 50° C. and about 100° C.

In some examples, at least about 50%; or at least about 60%; or at least about 70%; or at least about 80%; or at least about 90% of the inter-strand sheaths material comprises at least one component having a melting point of at least 50° C.

The inter-strand sheath forming material can comprise a single component, in this case, it will be a component having the above defined melting point. Yet, in some other examples, the inter-strand sheath material comprises a combination of materials, at least one having the said melting point, i.e. being solid at room temperature.

In some examples, the inter-strand sheath forming material comprises a gel forming material. This includes, in particular, gel forming, edible polysaccharides., such as those detailed hereinbelow.

In some other examples, the inter-strand sheath material comprises a protein. In some cases, to form the protein containing sheaths, protein solutions are casted into a mold. In such cases, the protein solution can be made of gluten, zein (corn prolamin), soy isolate, pea protein and others.

Further, in some other cases, the sheaths are produced by compressing protein mass into a desired thickness. In such cases, the protein can comprise TVP or HME and while in moisturized state, press them (optionally with heating).

In yet some further examples, the inter-strand sheath forming material comprises polysaccharides.

Some non-limiting examples of polysaccharides that can be included in the sheaths are pectin, alginate, carrageenan, chitosan, starch, cellulose derivatives (e.g. ethyl cellulose, carboxymethylcellulose, methylcellulose), galactomannan (e.g. fenugreek gum, guar gum, tara gum, locust beam gum, cassia gum).

In some examples, when the inter-strand sheaths comprise carrageenan, it is preferably κ-carrageenan. An exemplary amount of κ-carrageenan can be about 5% out of the total composition of the sheath forming material.

In some examples, the inter-strand sheaths material comprises a specifically designed carrageenan hydrogel including water in an amount that constitutes up to 80 wt% out of a total volume of the hydrogel; and when slightly dried, i.e. the hydrogel has between 50 wt% and 60 wt% water content, the slightly dried hydrogel is characterized by the following:
the amount of carrageenan is at least 5% CAR out of a total volume of the hydrogel;
the hydrogel has a storage modulus (G′) of at least 10 KPa within a temperature range of 25° C.-70° C.; and
the hydrogel having tensile strength at least 600 kPa and tensile strain at break of at least 15% as determined at 25° C.

The above exemplary carrageenan hydrogel can be obtained by treating a hydrogel forming mixture comprising at least 5 wt% CAR in in a form of a gel within an aqueous medium, said treatment of the gel is with an anti-solvent (e.g. ethanol) to form a solidifying hydrogel and dehydrating the solidifying hydrogel to obtain a dehydrated hydrogel comprising up to 50% water.

In some examples, the inter-strand sheaths comprise a combination of materials. When using a combination of materials, these may be of the same or different type, e.g. proteins, polysaccharides, fat etc. Yet, in some preferred examples, when the sheath comprises more than one material, it is essential that at least one has a melting point above room temperature.

In some examples, when the sheath comprises two or more materials, at least one is solid and at least one being liquid at a temperature between 30° C. and 70° C., at times between 40° C. and 60° C., at times between 50° C. and 70° C.

For example, the sheath forming material can be made from a combination of gel forming agents, such as the polysaccharides listed above, all being regarded also as gel forming materials.

Further, for example, the sheath forming material can be made from a combination of a gel forming material (e.g. a polysaccharide) and a fibrous material, such as cellulose fibers (micro or nano), citrus fibers (to strengthen the film matrix and to increase its melting temperature) as well as with TVP or HME.

The meat analogue can be characterized by some physical parameters, which are measured on a specimen/sample of the meat analogue product. The dimensions of the specimen can be selected dependent on the test performed, although, as shown in the non-limiting examples, the physical parameters are not limited to a specific sample dimension.

In some examples, the meat analogue is characterized by its hardness. Hardness of the meat analogue can be determined by a texture profile analyzer (TPA) system using Lloyd standard compression plates in room temperature (between 20° C.-25° C.) dimensions of the samples (for hardness) being about 20 mm*width 20 mm*thickness 20 mm (8000 mm³). Compression speed is 90 mm/min until a deformation of 50% is reached.

In connection with the above, it is noted that the sample/specimen on which the hardness is measured can be a single sample having essentially the above dimensions or a specimen formed from two samples stacked one on top of the other, e.g. two samples having each a thickness of 10 mm, thus providing together a 20 mm thick specimen. In some examples, when using two stacked samples, a glue can be added in between, to ensure fixation of the two samples, one to the other. Further, when stacking two or more samples, the hardness of the stacked specimen is determined in a direction that is perpendicular to the contact surface between the two or more stacked samples.

Interestingly, it has been found that the hardness of the specimen is at least 46 N (when measured perpendicular to the direction of the strands, preferably the Z or XP direction illustrated in FIG. 1A) independent on whether the tested specimen was from a single cut or a combination of cuts. Thus, for the purpose of the present disclosure, when referring to a hardness of at least 46 N, it is to be understood to also represent the hardness of smaller samples, as long as they are stacked into a sample having about 20 mm thickness along the measurement direction.

In some examples, at least one sample from the meat analogue can be characterized by a hardness of at least 46 N, irrespective to the direction of measurement of a sample of said meat analogue (the sample being as defined above, for example).

In some examples, the meat analogue can be characterized by a hardness of at least 52N when measured in a nominal direction of the protein strands of said meat analogue.

In some examples, the meat analogue is characterized by its compression modulus. Compression modulus of the meat analogue can be determined by a TPA system (same conditions described for hardness, i.e. texture profile analyzer (TPA) system using Lloyd standard compression plates in room temperature (between 20° C.-25° C.) dimensions of the samples (for hardness) being about 20 mm*width 20 mm*thickness 20 mm (8000 mm³). Compression speed is 90 mm/min until a deformation of 50% is reached. The modulus was calculated in the strain range of 0.02-0.1.

Similar to the hardness measurement, it is to be noted that the sample/specimen on which the compression modulus is measured can be a single sample having essentially the above dimensions or a specimen formed from two samples stacked one on top of the other, e.g. two samples having each a thickness of 10 mm (at times also glued one to each other), thus providing together a 20 mm thick specimen.

In some examples, at least one sample/specimen of the meat analogue is characterized by a compression modulus (Young’s modulus) of at least 0.5 MPa when measured in the P axis/nominal direction of the strands.

In some other examples, at least one sample of the meat analogue is characterized by an average compression modulus of at least 0.4 MPa when measured from at least two directions perpendicular to said nominal direction of the strands.

In some examples, the meat analogue is characterized by its tensile strength. Tensile strength of the meat analogue can be determined by tensile test systems. A tensile test pulls or stretches a sample and as a result the extensibility/elongation and tensile strength properties are measured in terms of force required to stretch and distance something can be stretched to. To this end, a specimen in elongated shape is gripped at either ends and stretched until it breaks.

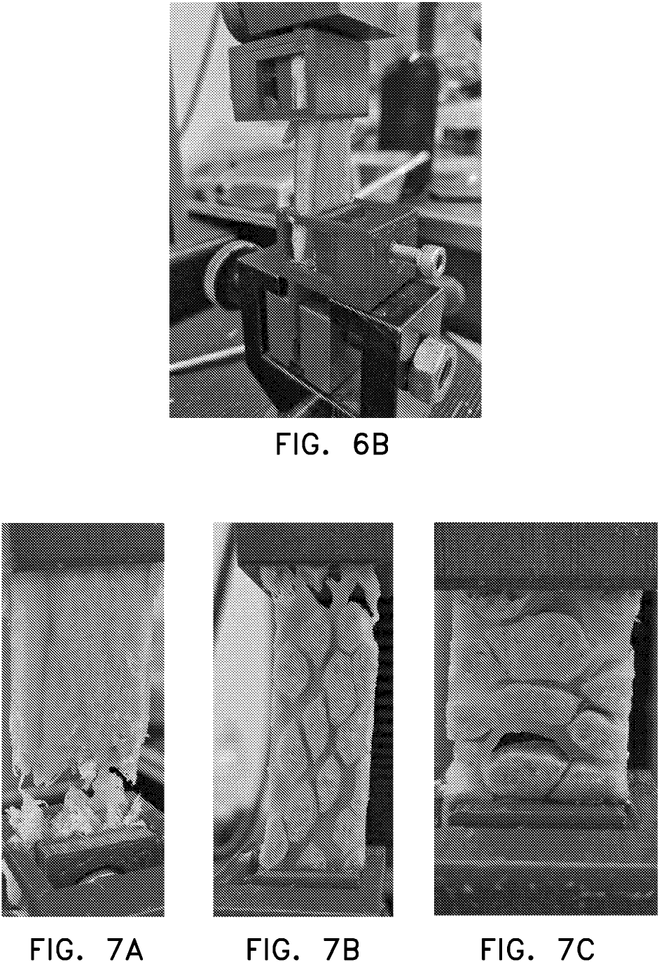

For determining tensile strength of the meat analogues disclosed herein, specimens of about 25*20*10 mm or even larger, e.g. 50*20*10 mm can be used. To ensure retention within the grippers, each specimen may be coated with a layer of cyanoacrylate glue (e.g. Loctite 406®, Henkel) at its edges, and then gripped by grippers made by 3D printing and comprising two plates equipped with 3 mm sharp spikes (see for example, FIG. 6A), having a contact area of about 10*20mm and operated with a manual screw. Then, at room temperature (about 23° C.±2° C.), each of the specimens can be stretched (from three different directions, P, XP, and Z) at a speed of about 20 mm/min.

It is to be noted that for the purpose of performing the tensile strength, other specimen dimensions can be used, e.g. 20*20*10 mm, as further exemplified hereinbelow. Thus, in the context of the present disclosure, when referring to a tensile strength of at least 0.012 MPa it is to be understood to be independent on the dimension of the cut from the meat analogue, as long as the dimensions allow the performing of the measurement.

In some examples, at least one sample of the meat analogue is characterized by a tensile strength of at least 0.035 MPa when measured in a nominal direction of said strands, e.g. when measured along the direction of the essentially aligned strands, e.g. P axis of FIGS. 1A or 1B.

In some other examples, at least one sample of the meat analogue is characterized by an average tensile strength of at least 0.012 MPa when measured from at least two directions perpendicular to said nominal direction of the strands (direction perpendicular to the P axis, e.g. XP and/or Z direction).

In some examples, the at least one sample of the meat analogue is characterized by a tensile strength that is at least 50% higher than that of the protein material forming the strands.

In some examples, the rheological properties of at least one sample of the meat analogue can be defined by the relationship between the physical properties of the sheath forming material and that of protein strand forming material. Accordingly, the meat analogue can be characterized by any one of:
having sheaths material compression modulus that is at least twice that of the strands material, when measured in a direction perpendicular to the direction of the strands;
having sheaths material tensile modulus that is at least twice that of the strand’s material when measured in a direction perpendicular to the direction of the strands;
having a sheaths material elongation to break that is least 50% higher than the elongation to break of the strands, when measured in a direction perpendicular to the direction of the strands.

The meat analogue disclosed herein is also characterized by its anisotropic behavior, which is similar to that of true meat, i.e. having a difference in the physical properties when the physical property is measured from different directions of a meat analogue sample. For example, the difference between tensile modulus and tensile strength of a sample of the meat analogue would be greater between P and XP/Z direction than between the XP and Z directions (definition of directions as defined in FIGS. 1A-1B and further below).

Further, the meat analogue disclosed herein was found, by a tasting panel that after cooking and at serving temperature of about 40° C., to have strands that visually and organoleptically are similar to that of true meat. The same tasting panel also determined that the meat analogue has a browning reaction (also known by the term Maillard reaction) similar to that of true meat. Without being bound by theory, it is believed that the presence of the sheath forming material contributes to the browning reaction, which does not occur in the absence thereof.

Some non-limiting examples of physical parameters of meat analogues are disclosed herein in the Examples. Specifically, for illustration only, the following meat analogues were tested in which the protein composition was the same and the sheaths forming material was different.

Protein composition (for all three non-limiting, exemplary, meat analogues): prepared by mixing in a standard domestic mixer 15% gluten (vital wheat gluten by Sorpol), 60% tap water, 5% canola oil (‘Shufersal’), 5% red spice colorant (‘Texturot’), and 15% textured vegetable protein (TVP SUPRO MAX 5010 IP)
Meat analogue I: sheath material composition comprising a sheath made of 5% κ-carrageenan (Genugel type wr-78by CPkelco) (herein “Car”).
Meat analogue II: sheath material composition comprising a sheath made of Gluten only (herein “Glu”).
Meat analogue III: sheath material composition comprising a sheath of 5% κ-carrageenan in water which layer is coated with an external layer of 0.02 g per cm² gluten powder from each side of the Car film (herein “Car-Glu”)

Tables 1A-1C and Tables 2A-2B below (examples) provide the compression modulus, hardness and tensile strength of samples of the non-limiting examples, tested under the conditions described above (the content of the Table forming part of the present disclosure).

The meat analogue can be of any shape or dimension. The meat analogue can be defined using spatial dimensions, taking into consideration its width axis (“w”, also referred to as the XP axis, being in FIGS. 1A-1B, a direction perpendicular to the direction of the strands), height axis (“h” also referred to the Z axis, being in FIGS. 1A-1B a direction perpendicular to the direction of the strands) or length axis (“l”, parallel to the strands nominal direction, also referred to as the P axis, being in FIGS. 1A-1B, a direction essentially parallel to direction of the strands).

In some examples, the meat analogue is provided in a form of a whole meat slab, where the nominal direction of the strands is essentially parallel with the longitudinal axis of the slab.

Further, when defining a steak dimension cut from a slab, one refers to its length, height and width dimensions. In some examples, a steak is cut from a meat slab perpendicularly to the P axis such that it has the same width and height of the slab from which it is cut, but the length value (i.e. the steak thickness) would typically be 0.5-10 cm, irrespective of whether the slab was a large, medium or small slab.

In some other examples, the steak is cut from any direction of the slab, i.e. not necessarily perpendicular to the direction of the strands. For example, the steak can be cut along the direction of the strands. Irrespective of the direction of cutting, the physical parameters described hereinabove and below are always determined in a direction determined with respect to the direction of the strands. For example, the hardness would typically be determined perpendicular to the direction of the strands.

In some further examples, the steak can be cut in diagonal direction with respect to the XP, P and Z directions.

In some examples, the meat analogue is produced already in a form of a steak where the directions of the strands are along the width of the steak portion (See, FIG. 1B, for example). Therefore, when producing a steak portion, the height of the printed product corresponds with the width of the steak portion, the thickness of the steak portion corresponds with the length of the strands.

In some non-limiting examples, the dimensions of a steak according to the present disclosure is in the ranges of length (P axis) of between 1 cm and 5 cm, e.g. about 3 cm, height (Z axis) of between 5 and 10 cm, e.g. about 6 cm, and width (XP axis) of between 5 and 12 cm, e.g. about 9 cm).

To obtain the meat analogue disclosed herein, a strand of the protein is digitally printed onto a printing bed in a manner that a single convoluted strand or a plurality of individual strands are laid onto or placed onto a printing bed with segments between folds of the single strand or between the plurality of strands being preferentially essentially parallel along their longitudinal axis and gaps are maintained between at least a portion of the folds or strands. Between layers of the strands, the inter-strand sheaths forming material is applied. In this manner and in accordance with principles of digital printing, a multiplicity of monolayers of strands are formed into a 3D food product.

Specifically, provided by the present disclosure is an additive manufacturing method for producing a meat analogue, the method comprising:
(a) dispensing one or more strands of protein into at least one protein layer, said protein layer comprising essentially aligned protein strands, at least a portion of said protein strands being spaced apart from its neighboring strand;
(b) over said at least one protein layer, dispensing an inter-strand sheaths material;
(c) repeating said steps (a) and (b) until reaching a desired dimension for said meat analogue;
said method is such that sheaths material occupies spaces between neighboring strands.

It is to be noted that the repeat of step (a) is preferably such that the disposed strands in one layer are essentially in the same direction of the strands in the previously disposed layers. In other words, the strands in the complete product, are essentially aligned across the product when viewed from any direction thereof.

A unique feature of the present disclosure resides in the spaces or gaps between at least a portion of the protein strands within a protein layer and the alignment of at least some of the strands of the previously or subsequently placed protein layers (i.e. the sandwiching layers) parallel to such gaps, as illustrated in FIGS. 2A-2G. The gaps have dimensions that fit the dimensions of the strands such that they can receive/embrace protein strands from the neighboring layers.

In the context of the present disclosure, when referring to a protein layer it is to be understood as a layer of protein strands that can be composed of a single, monolayer of protein strands, or two or more monolayers of protein strands, e.g. a set of monolayers formed one on top of another in a 3D multi-layer structure. It is to be understood that the monolayer can be a full layer, i.e. extending on the entire surface of the previously formed monolayer (onto which it is placed), or a partial monolayer, e.g. occupying only a portion or portions of the previously formed monolayer, or even a single strand placed on top of a nreviouslv formed monolayer.

In some examples, a protein layer comprises a monolayer of protein strands. In some other examples, the protein layer comprises two monolayers, one laid over and in direct contact with its previously formed monolayer. In yet some other examples, the protein layer comprises up to 6, at times, up to 5, at times up to 4 monolayers within a layer, each one laid over and in direct contact with its previously formed monolayer.

The inter-strand sheaths forming material is dispensed in a manner interconnecting between two sequential protein layers.

In some examples, at least a portion of the spaces between strands previously laid on the printing bed have dimensions that allow a superimposed inter-strands forming material to inter-cross the protein layer onto which it is overlaid and come into contact with a previously dispensed inter-strand sheaths forming material.

In some examples, the inter-strand sheaths forming material is applied onto the protein layer in a form of a solid or semi-solid sheet (film). In the context of the present disclosure it is to be understood that the sheet can be a flat sheet as well as an undulated sheet having alternating elongated concave segments configured to fit over at least a portion of said protein strands. For example, the sheet can have a zig-zag cross-sectional configuration, or a wavy cross-sectional configuration such as that illustrated in FIG. 2G.

The sheet (film) formed of the inter-stand sheath material can be placed over the strand layer either as an already laid open sheet (e.g. pick and place mode), or it may be provided as a rolled sheet that is un-rolled when placed over the protein strands layer.

In some examples, the sheets contain fibrous elements (e.g. proteins, polysaccharides etc). In such cases, the sheet (film) can be produced by using electrospinning techniques. In some other cases, the sheet can be in the form of a non-woven mesh, formed making use of techniques from the non-woven fabric industry. For example, the non-woven mesh can be created via dispensing of fibrous material within a carrier on a planar surface.

In some other examples, inter-strand sheaths forming material is applied in liquid form by any one of spraying, brushing, dipping, dispensing, ink-jet printing, screen printing and extrusion. To this end, the applying of the inter-strand sheath forming material is at temperatures at which the inter-strand sheaths forming material is liquid and once cooled, the inter-strand sheath forming material solidifies.

In some examples, screen printing techniques can be used to form the inter-strand sheaths. For example, polysaccharides such as carrageenan, pectin, chitosan, starch and/or ethyl cellulose melt are smeared on polyester net having a known pore size and known geometrical size. Then, with a single motion of silicone scraper the liquid is deposed on a substrate. The substrate can be the strands layers or a secondary substrate from which the film is moved to the strands layer.

In yet some other examples, inter-strand sheaths forming material is applied in the form of a powder, which is then subjected to a post-application process that liquidizes, dissolves or hydrates the powder into a mass that thereby occupies the gaps between the strands. The post-application process can include, inter alia, any one or combination of hydration and/or thermal treatment, as further discussed below. Such post-application treatment is typically for activating the curing of the components forming the inter-strand sheaths.

Powder material for forming the inter-strand sheaths can be made of protein powder, such as soy, gluten, pea, potato etc., as well as from gel forming polysaccharides in powder form.

The manufacturing process can comprise application of other materials within or onto an already deposited protein and/or sheath forming material. For example, the manufacturing process can comprise the application of fat material onto at least a portion of the protein strands; and/or applying edible additives; and/or applying water-based components.

The protein strands as well as any other material to be incorporated within the product can be placed manually or digitally according to an assembly plan, defining spatial arrangement of the protein strands one with respect to its neighboring strand, or when the strand is a folded strand, a fold with respect to its neighboring fold; and the over layering with the sheath forming material.

The meat analogue assembly plan can be prepared by constructing a detailed list of data points describing the different combinations of protein strands and inter-strand sheath material and other required components (e.g. fat component, water based component), as well as the different order in which layers are assembled one on top on the other.

The execution of the assembly plan can be performed using a computer program capable of creating complex 3D models according to the desired assembly plan, and then use slicing software as known in the art to create a final file containing all of the data in the meat assembly plan. The meat analogue assembly plan is typically digital, provided in a digital file with a format such as txt, xml, html or others. In some cases, the meat analogue assembly plan can be a human language file, or a computer readable language.

In some examples, the assembly plan is represented as at least one of a digital file, a txt file, an XML file, a CAD file, a 3DS file, a STL file, an OBJ file, or a g-code file.

In some cases, the assembly plan is a digital 3D model file utilizing known industrial modeling tools format such as Solidworks or CAD.

In some examples, the assembly plan is a 3D model file, transformed by additional software to control the system list of operations. One non-limiting example can be an STL 3D model file, transformed by 3D slicing software into a G-Code format file uploaded to a 3D printer.

In some examples, the meat analogue is printed using two 3D printers.

In some examples, the 3D printer comprises two or more printer heads/deposition heads, so as to enable the deposition of at least the protein strands and at least one other non-protein material (e.g. the sheath forming material, the fat component, the water based component) without the need to replace the cartridge/syringe providing the printed component. In some examples, the use of a 3D printer with two or more printer heads allows the simultaneous printing of different components, possibly without cross-interreference between the printing of different components.

The protein material forming the protein strands can be loaded to syringes of different sizes, or syringes compatible with adjustable tips (e.g. Luer-Lok™). Each syringe can be loaded onto a separate printing station, with a deposition mechanism comprising of a motor, control unit and an adjustable rod as typically available with 3D printers. The printer processor is able to control the deposition rate of each syringe by the speed of movement in the motor, allowing for different amounts of component material to pass through the nozzle, or in combination with the print-bed motor movement, create different width of strands from a single nozzle size.

The operation and equipment to be used for relevant printer head can be adjusted or specifically selected based on the component to be dispensed therethrough, e.g. based on the viscosity or consistency of the component. For example, different motors and different gears can be introduced to provide stronger forces on the extruding ram/auger screw/progressive cavity pump, so as to enable flow of high-viscosity materials.

In addition, existing 3D printers can be redesigned to include larger deposition syringes or canisters, for example, vessels made of food-grade stainless steel having a capacity of at least 60 ml, at least 80 ml, at least 100 ml, at least 120 ml, or more.

Heating elements can also be installed on cartridges/syringes to affect texture and/or fluidity of the dispensed protein material. By way of example, heating can cause some level of denaturation of the protein composition in situ or may allow for the adjustment of viscosity in any of the fat, moisture, and protein composition.

The protein strands and sheath forming material can be subjected to intermediate or post-assembly processing steps.

By the use of the term “intermediate processing” it is to be understood as a processing step applied onto the already deposited protein strand(s) and/or protein layer(s) and at least one inter-strand sheath material, and yet before all protein strands and sheath material have been completely deposited (i.e. in the middle of the manufacturing process). In other words, the processing step is applied after dispensing N numbers of protein layers and/or M numbers of inter-sheath forming material, N and M being the same or different, and each being an integer equal or above 1.

By the use of the term “post-assembly processing step” it is to be understood as a processing step applied after all the protein layers and the inter-strand sheath materials have been deposited according to the assembly plan.

In some examples, the processing step comprises removing or introducing moisture from the already deposited material (rehydration or dehydration).

In some other or further examples, the processing step comprises thermal treatment. Thermal treatment can include infra-red (IR) radiation, heating or cooling.

In some other or further examples, the processing step comprise UV radiation. For example, the processing step can comprise exposure to a Mercury lamp or UV LED source, producing peaks between 350 nm and 420 nm, utilizing photo-initiators, e.g. CIBA Irgacure 2959, at about 0.1% to 1% w/w.

In yet one preferred example, the processing step comprises applying pressure onto dispensed layers.

In some examples, the pressure is applied in a direction perpendicular to the surface of the layers (i.e. perpendicular to the direction of the strands and/or to the deposited sheath sheet).

In some other examples, the pressure is a vacuum pressure.

The pressure applied onto the layered product results in volume reduction and/or density increase in the manufactured product.

When referring to volume reduction, the pressure can result in at least 5% change in the volume of the deposited layers, before and after application of the pressure.

When referring to increase in density, the pressure can result in at least 5% increase in density. The increase in density can be determined by Archimedes’ method, aga gravimetric buoyancy method according to the following equation:

$$ρ = \frac{\text{A}}{\text{A} \text{-} \text{B}} \left({ρ}_{0} - {ρ}_{\text{L}}\right) + {ρ}_{\text{L}}$$

p = Density of the sample
A = Weight of the sample in air
B = Weight of the sample in the auxiliary liquid
p₀ = Density of the auxiliary liquid
p_{L} = Density of air

Without being bound thereto, it is believed that the pressure also assists in removing any trapped air within the voids formed between strands, thereby improving the integrity of the resulting meat analogue. Further, the pressure can improve the adhesion between the layers and the inter-strand sheath material. At times, an adhesion material can be added, such as gluten powder, to improve the adhesion of the sheath material to the facing strands.

The intermediate or post deposit processing step can also result in any one of the following: solidify a component of the meat analogue after it is deposited, to stabilize a layer before printing the next layer; to induce or facilitate texturization after deposition, to induce or facilitate bonding of components within the deposited materials.

After the assembly is completed, the resulting manufactured meat analogue can be further processed according to conventional culinary methods, including frying, boiling, chopping, cooking, etc.

For illustration of possible assembly plans, reference is made to FIGS. 2A-2G which illustrate some non-limiting examples of the layering of the protein layer and the inter-strand sheaths material to form a meat analogue and the subsequent processing step in accordance the present disclosure. For simplicity, like reference numerals to those used in FIG. 2A, will be used also in FIGS. 2A-2G.

FIG. 2A provides a schematic cross-sectional illustration of an assembly plan 202A for producing a meat analogue 200A in accordance with one embodiment of the present disclosure. The assembly plan 202A includes distinct protein strands 210, each of which having a gap 212 between neighboring strands within a layer 214. Each layer 214 is formed of a monolayer and each monolayer is separated from a previous or subsequently disposed layer (below or above layer, respectively) by an inter-strand sheath film 216, presented in this illustrated embodiment as a flat sheet. Once the layers are in place (the protein strands and the sheaths material), a processing step takes place, as illustrated by arrow 218, that results in the compression of the layers and the pressing of the inter-strand sheath material into the gaps between the strands, thus converting the air filled gaps with inter-strand mass 220. The cross section of this assembly configuration resembles a honey-comb structure.

It is noted that while the strands, gaps and sheets in FIGS. 2A-2G are illustrated as having the same dimensions, these are not necessarily and in a single meat analogue the dimensions (as well as the composition) of the strands and sheets, and the dimensions of gaps can vary, all being according to the pre-defined assembly plan.

FIG. 2B provides another possible configuration for a meat analogue 200B, in accordance with assembly plan 202B. Specifically, assembly plan 202B comprises two different layer arrangement, a first layer arrangement 214 wherein each strand 210 is spaced apart within the layer from its neighboring strand by a gap 212, and a second layer arrangement 224, comprising pairs of strands 230, each pair being spaced apart from its neighboring pair within a layer by a pairs gap 232. Gap 212 and pairs gap 232 are not necessarily of the same dimension. After applying pressure 218, inter-strand sheath material 216 is pressed into gaps 212 and pairs 232 between strands 210 and the pairs 230, to form inter-strand mass 220.

FIG. 2C provides yet another possible configuration for a meat analogue 202C, based on assembly plan 200B. Specifically, assembly plan 200C is designed to form protein layers 214, each being composed of two monolayers of protein strands 234A and 234B.

FIG. 2D provides yet another possible configuration for a meat analogue 202D, based on assembly plan 200D. Specifically, assembly plan 200D is designed to provide layers 214 of protein strands of random spacing between the strands, such that some strands within a layer are disposed without any contact with a neighboring strand, such as strand 212 and some are disposed without a gap from at least one neighboring strand to form, for example, paired stands, such as paired strands 230, and some are disposed.

FIG. 2E provides yet another possible configuration for a meat analogue 202E, based on assembly plan 200E. Specifically, assembly plan 200E is designed to provide layers 214 of protein strands of only low level (i.e. small) spacing between the strands, such that some of the strands are paired, such as paired strands 230, some of the strands within a layer form a segment of contiguous parallel strands, such as segment 236, and some are entirely spaced apart, such as strand 212.

FIG. 2F provides yet another possible configuration for a meat analogue 202F, based on assembly plan 200A, yet with some strands being replaced with fat containing strands 238.

FIG. 2G provides yet another possible configuration for a meat analogue 202G, based on assembly plan 200G. Specifically, assembly plan 200G is designed to make use of an undulated film 240 of inter-strand sheath material that is placed between each layer 214. Without being bound by theory, using an undulated film of a type shown in FIG. 2G assists in reducing the amount or preventing the formation of air voids between the adjacent strands. While air voids, if present, are typically reduced or removed during the compaction stage, using the undulated sheaths may further assist.

It is noted that while the assembly plans may differ in the manner of constructing the layers, the resulting meat analogue may have the same eventual properties. This can be exhibited by the similarity between the schematic illustration of meat analogue 202A and that of meat analogue 202G.

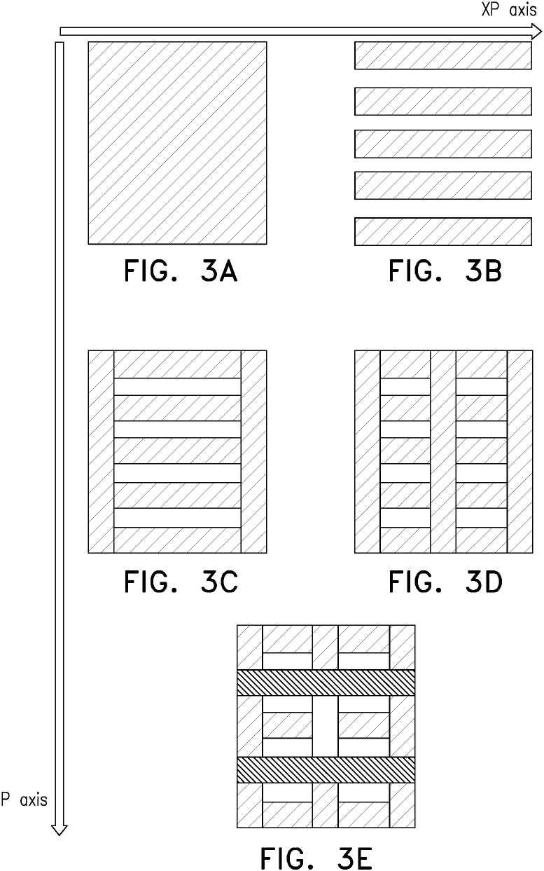

The inter strand sheaths material can be prepared to have different sheet like configurations, some of which are illustrated in FIGS. 3A-3E.

Specifically, while the more common form would be as a complete sheet, such as that illustrated in FIG. 3A, the sheath material can be applied as individual stripes, e.g. overlaid on the protein layer in parallel form one with respect to the other, as illustrated in FIG. 3B.

In some examples, the stripes can be framed, as illustrated in FIG. 3C and/or reinforced with a crossing stripe, as illustrated in FIG. 3D.

In yet some further examples, the stripes can be combined with stripes of a different material, e.g. two types of sheath forming material (distinguished by stripe pattern), as illustrated in FIG. 3E.

As used herein, the forms “a”, “an” and “the” include singular as well as plural references unless the context clearly dictates otherwise. For example, the term “a protein based component” includes one or more components of differnet protein compositon which are capable of forming a protein based segment within the meat analogue.

Further, as used herein, the term “comprising” is intended to mean that, for example, a component, e.g. sprotein composition includes the recited protein, but not excluding other substances including othe proteins, such as fat and water. The term “consisting essentially of” is used to define, for example, compoents which include the recited substances but exclude other substances that may have an essential significance on the characteristics of the resulting meat analogue. “Consisting of” shall thus mean excluding more than trace amounts of other elements. Embodiments defined by each of these transition terms are within the scope of this disclosure.

Further, all numerical values, e.g. when referring the amounts or ranges of the elements constituting the component disclosed herein, are approximations which are varied (+) or (-) by up to 20%, at times by up to 10% of from the stated values. It is to be understood, even if not always explicitly stated that all numerical designations are preceded by the term “about”.

Further, as used herein, the term “percent”, or “%”, refers to percent by weight, unless specifically indicated otherwise.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### NON-LIMITING EXAMPLES

### Example 1 - Protein Compositions and Sheath Compositions

Three meat analogue specimens have been prepared, which differ in the presence and composition of sheaths between the protein strands. each meat analogue containing the same protein composition in the dough forming the protein strands, which included the following:

### Preparation of the Protein Containing Dough (Strand Forming Material)

The protein dough was made by mixing in a standard domestic mixer 15% gluten (vital wheat gluten by Sorpol ™), 60% tap water, 5% canola oil (Shufersal™), 5% red spice colorant (Texturot™), and 15% textured vegetable protein (TVP SUPRO MAX 5010 IP). The protein composition is referred to herein by the abbreviated term “NSH_ref”)

### Preparation of the Sheath Forming Materials

Films from Gluten powder: the gluten films were formed in situ, i.e. by coating a protein strand layer with 0.002%-2% (gr/cm²) with gluten and subsequently activating the formation of a film by the disposed film by heating to 100° C. for 45 min. The gluten films are referred to herein by the abbreviation “Glu”.

Films from carrageenan: the films were made by mixing a solution of 5% carrageenan (CPkelco Genugel wr78) in water (w/w) and heating the mixture during high shear. Then, placing the hot melt in a mold in an amount sufficient to form 0.4 mm thick films, and allowing the films to sufficiently cool (below carrageenan Tm). The carrageenan films are referred to herein by the abbreviation “Car”.

Preparation of carrageenan-gluten films: The Car-Glu films were prepared by first preparing the carrageenan film as described and coating the carrageenan film with gluten powder at a concentration of about 0.02 g of gluten per 1 cm² of film. The gluten coated film is then placed over the protein stands layer and the coated film is activated by heating as described with respect to the Glu films. The carrageenan-gluten films are referred to herein by the abbreviation “Car-Glu”.

### Formation of the Meat Analogue

The prepared protein dough was extracted into strands with an electrical caulking gun (Makita DCG180) equipped with a 4 mm nozzle. The strands were then aligned in layers, such that the strands in each layer are spaced apart (the distance between each pair of strands being essentially the thickness of a strand). On top of each protein layer a film forming (sheath forming) material was placed (either type as defined above).

The next protein strand layer was then placed on top of the sheath material such that each strand fits on top of the gap of the two aligned, previously placed, strands.

Four types of meat analogue were prepared:
Ref meat analogue: comprising protein strands only (“NSH-Ref”).
Meat analogue I: sheaths material composition comprising 5% κ-carrageenan (“Car”)
Meat analogue II: sheaths material composition comprising pure gluten powder at a coverage over the protein stands of 0.02 g per 1 cm² (“Glu”)
Meat analogue III: sheath material composition comprising 5% κ-carrageenan, covered from both sides with 0.02 g of gluten powder per 1 cm² of film (“Car-Glu”)

The building of the layers and placement of the sheath forming material was continued until the desired meat analogue (slab dimension 10 cm*10cm) was obtained.

All slabs were cured in Sous Vide @ 100° C., until internal temperature of the labs reaches 95° C. and was maintained at this temperature for at least 15 minutes.

The different slabs were then cooled in a fridge @ 4° C. overnight before testing. Tests were conducted after samples reached ambient temperature (20° C.-25° C.).

FIGS. 4A-4C are images of assembled layers of a meat analogue of composition carrageenan with gluten powder (CarGlu, Formulation III). Specifically, FIG. 4A and FIG. 4B are side view and top view of photographic images of the assembled layers of protein strands (410) and alternating inter-strand sheath films (416), where FIG. 4C provides a side view after compressing of the assembled layers using vacuum of 5-7 mbar.

FIGS. 5A-5B are images of a meat analogue obtained following a manufacturing process of a type illustrated in FIG. 2A and with a composition of carrageenan films; FIG. 5A providing an optical image while FIG. 5B providing the same image with a scale.

### Example 2-Characterization

Samples of a meat analogues of NSH-Ref, Car and Car-Glu, prepared as described above were prepared and constructed according to assembly plan illustrated in FIG. 2A. each meat analogue was then evaluated for its hardness and tensile properties.

### Tensile Strength

Tensile strength was measured for specimens of 50*20*10 mm (cuts from the printed slab of 10 cm*10 cm). The specimens were coated with cyanoacrylate glue at their edges to enhance the gripping behavior and prevent slipping. The specimens were gripped by grippers 3D printed using PLA material and having a contact area of 10*20 mm with sharp 3 mm spikes (see FIG. 6A) and operated with a manual screw. Then, at room temperature (23° C.±2° C.), each of the specimens was stretched using LLOYD TPA instrument equipped with a 1KN load cell at a speed of 20 mm/s. FIG. 6B provides an image of a tensile strength measurement of formulation I (CAR), showing the specimen stretched while being held between two grippers.

The results of measurement of tensile strength of a sample comprising CAR along the P, XP and Z axes are provided in FIGS. 7A-7C, respectively.

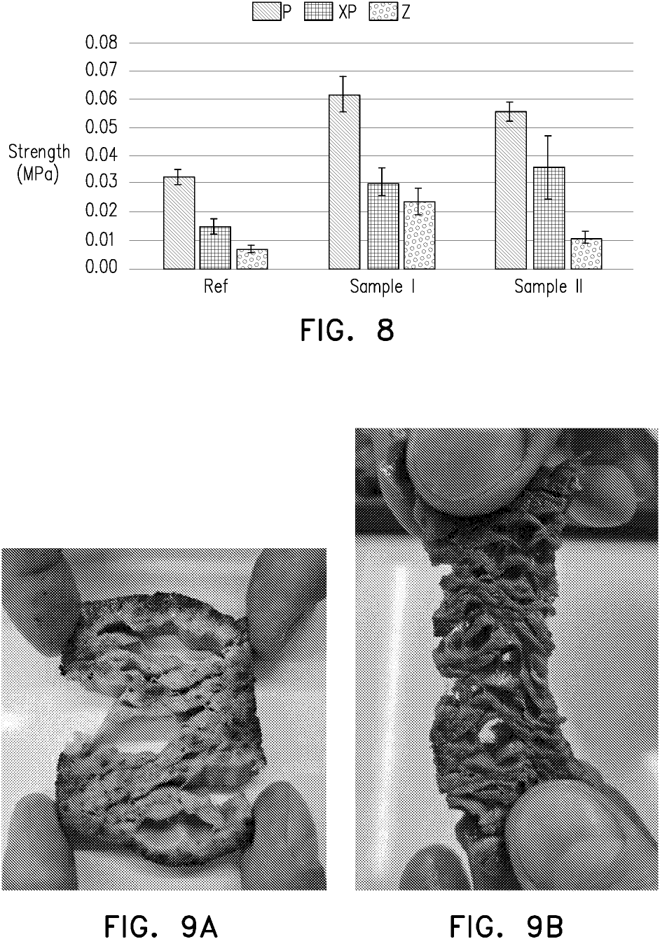

The results are also presented in Table 1A and FIG. 8. Specifically, FIG. 8 is a bar graph showing the tensile strength of the evaluated sample (based on the data in Table 1A), in three different directions.

Table 1A provides the tensile strength of the different specimens along the different axes.

TABLE 1A

Tensile strength
Tensile Strength (MPa)

| | P | Average XP/Z* |
|---|---|---|
| Ref | 0.032 | 0.011 |
| I | 0.062 | 0.026 |
| III | 0.056 | 0.019 |

* Average XP/Z denotes the average of at least two directions perpendicular to P

The results show that the higher tensile strength appears in the P axis which is the direction of the strands. In addition, Table 1A and FIG. 8 shows that when using inter-strands sheaths of the type disclosed herein, the tensile strength of the meat analogues improves in all directions, as compared to the reference.

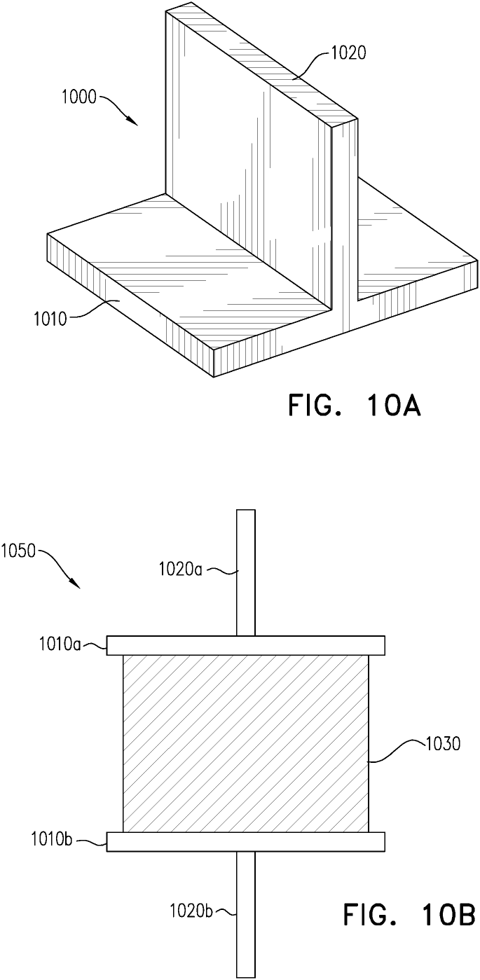

FIGS. 9A-9B are images of meat analogue (CAR-Glu, FIG. 9A) vs. true meat (FIG. 9B) showing the ‘holding’ of the protein strands by the inter-strand sheath material, similar to the behavior of connective tissue in true meat, thus providing a proof of concept of the present technology.

In a further test, smaller specimens of 25*20* 10 mm comprising CAR as the inter-sheath forming material, were used. The specimens were glued at their edges and placed in the grippers shown in FIG. 6A. Table 1B shows the maximal load (MPa) for two identical tested specimens.

TABLE 1B

Tensile strength of 25*20*10 mm specimen using grippers

| Specimen (25*20*10) | Max Load (MPa), XP axis |
|---|---|
| Specimen 1 | 0.06 |
| Specimen 2 | 0.056 |

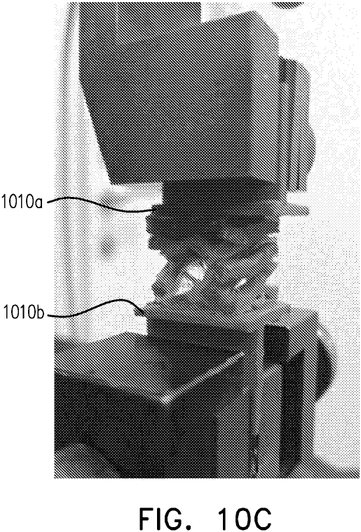

In yet a further test, even smaller specimens (CAR) of 20*20*10 mm were used. Each tested specimen was placed between a pair of T-shaped fixtures, as illustrated in FIGS. 10A-10C. To allow stretching, the specimens were glued to the plates using cyanoacrylate glue and after allowing the glue to dry (about 10 minutes), the measurement begun (speed of 20 mm/min).

Specifically, FIG. 10A shows a single T-shaped fixture 1000 including a plate 1010 and an arm 1020, while FIG. 10B shows a system 1050 including a pair of T-shaped fixtures 1000a and 1000b, and their respective arms 1020a and 1020b, holding a tested specimen 1030 between plate 1010a and plate 1010b of each respective T-shaped fixture.

Upon stretching (speed of 20 mm/min), the glued edges of the specimen were maintained adhered to the plates 1010a and 1010b, as shown in FIG. 10C.

The tensile strength measured perpendicular to the strand’s direction, of 4 replicate specimens (of same dimension and composition) using the T-shaped fixtures are provided in Table 1C.

TABLE 1C

Tensile strength of 20*20*10 mm specimen using T-shaped fixtures

| Specimen (20*20*10) | Max Load (MPa) |
|---|---|
| Specimen 1 | 0.034 |
| Specimen 2 | 0.042 |
| Specimen 3 | 0.0455 |
| Specimen 4 | 0.0425 |

The above results show that irrespective of the dimensions of the tested specimen, the tensile strength when measured in one direction perpendicular to the strand’s direction is at least 0.033 MPa.

### Young’s Modulus and Hardness

Young’s modulus and hardness strength were determined using the meat analogues I (Car) and III (Car-Glu) describes above and on the reference sample comprising the protein strands only (Ref). To this end, cubic specimens of the meat analogue having dimensions of height 20 mm*width 20 mm*thickness 20 mm (8000 mm³) were cut. Compression speed is 90 mm/min until a deformation of 50% is reached. The modulus was calculated in the strain range of 0.02-0.1. The compression modulus (Young’s modulus) and hardness were determined using LLOYD TPA system equipped with a 1KN load cell as described above. The results are provided in Table 2A below.

TABLE 2A

Physical properties of exemplary meat analogues specimens

| Specimen | Compression Modulus [MPa] | | | | Hardness [N] | | | |
|---|---|---|---|---|---|---|---|---|
| Direction | P | XP | Z | Avr XP/Z* | P | XP | Z | Avr XP/Z* |
| Ref | 0.39 | 0.34 | | 0.34 | 51.9 | 45.1 | | 45.1 |
| I | 0.49 | 0.43 | 0.56 | 0.5 | 54.5 | 39.3 | 56.0 | 47.7 |
| II | 1.05 | 1.06 | 1.54 | 1.3 | 125.8 | 113.2 | 160.7 | 137.0 |
| III | 0.60 | 0.45 | 0.88 | 0.67 | 78.3 | 62.1 | 107.4 | 62.1 |

* Avr XP/Z denotes the average of at least two directions perpendicular to P

In a further test, the specimens were prepared from a combination of two thinner cuts (20*20*10 mm at XP direction), which were then stacked one on top of the other such that the direction of the strands in the two cuts are essentially aligned, to provide a final specimen of 20*20*20 mm and placed between two compression plates. The specimens were then compressed to 50% of their initial dimension (in one direction) and the hardness along the XP direction was determined for 3 exemplary specimens (of same composition and dimensions). The results (not shown) were found to be within the range of the present invention and similar to those exhibited in Table 2A, thus supporting the understanding that the hardness can also be measured on cuts of smaller dimension (as compared to the specimen of Table 2A), and combined into the same overall dimension.

1-49. (canceled)

50. An edible meat analogue, comprising:
a plurality of protein strands and inter-strand sheaths material;
wherein in at least one sample of said edible meat analogue, the following conditions are fulfilled:
said plurality of protein strands are essentially aligned along a P axis of said at least one sample,
at least a portion of the protein strands are at least partially surrounded by the inter-strand sheaths material;
said inter-strand sheaths material comprises at least one component that has a melting point above 30° C.;
said inter-strand sheaths material forms a network interconnecting between at least two neighboring, spaced apart, protein strands; and
wherein said inter-strand sheaths material is selected to provide at least one of the following physical properties:
an average hardness of at least 46 N when measured from at least two directions perpendicular to a nominal direction of the protein strands in a specimen of said edible meat analogue; and
an average tensile strength of at least 0.012 MPa when measured from at least two directions perpendicular to said nominal direction of the strands in a specimen of said edible meat analogue.

51. The edible meat analogue of claim 50, wherein said inter-strand sheaths material occupy spaces between neighboring strands.

52. The edible meat analogue of claim 51, wherein said spaces have a dimension of between 50 µm and 5 mm.

53. The edible meat analogue of claim 50, wherein said inter-strand sheaths material comprise a protein.

54. The edible meat analogue of claim 50, wherein said inter-strand sheaths material comprise a polysaccharide.

55. The edible meat analogue of claim 50, wherein said inter-stand sheaths material comprise a protein selected from at least one of plant protein, Texturized Vegetable Protein (TVP), or High Moisture Extruded (HME) proteins.

56. The edible meat analogue of claim 50, wherein said inter-strand sheaths comprise κ-carrageenan.

57. The edible meat analogue of claim 50, wherein said inter-strand sheaths material comprise gluten.

58. The edible meat analogue of claim 50, wherein said inter-strand sheaths material comprises a combination of two or more components with different melting points, at least one being solid and at least one being liquid at a temperature between 30° C. and 70° C.

59. The edible meat analogue of claim 50, being characterized by at least one of the following:
compression modulus of at least 0.5 MPa when measured in a nominal direction of said protein strands in a specimen of the edible meat analogue;
average compression modulus of at least 0.4 MPa when measured from at least two directions perpendicular to said nominal direction of the strands in a specimen of said meat analogue;
hardness of at least 52N when measured in a nominal direction of the protein strands of a specimen of said meat analogue; or
tensile strength of at least 0.035 MPa when measured in a nominal direction of said strands in a specimen of said meat analogue.

60. The edible meat analogue of claim 50, being in a form of a steak with the protein strands being in direction perpendicular to the longitudinal axis of the meat analogue.

61. An additive manufacturing method for producing a meat analogue, the additive manufacturing method comprising:
(a) dispensing one or more strands of protein into at least one protein layer, said at least one protein layer comprising essentially aligned protein strands, at least a portion of said protein strands being spaced apart from its neighboring strand;
(b) over one or more protein layers, dispensing an inter-strand sheaths material; and
(c) repeating said steps (a) and (b) until reaching a desired dimension for said meat analogue;
wherein said inter-strand sheaths material occupies spaces between neighboring strands.

62. The additive manufacturing method of claim 61, wherein protein strands are dispensed in a manner whereby at least a portion thereof fits into spaces between strands of a previously dispensed protein layer.

63. The additive manufacturing method of claim 61, wherein said inter-strand sheaths material is dispensed in a manner interconnecting between at least two sequential protein layers.

64. The additive manufacturing method of claim 61, wherein at least a portion of the spaces between strands have dimensions that allow dispensed inter-strands forming material to inter-cross the protein layer onto which it is overlaid and come into contact with a previously dispensed inter-strand sheaths material.

65. The additive manufacturing method of claim 61, wherein said inter-strand sheaths material is applied onto a protein layer in a form of a sheet.

66. The additive manufacturing method of claim 61, wherein said inter-strand sheaths material is dispensed in a liquid form or in powder form.

67. The additive manufacturing method of claim 61, wherein said applying of the inter-strand sheaths material is at temperatures at which said inter-strand sheaths material is liquid and said method comprises cooling the inter-strand sheaths forming material once applied, to a temperature at which it solidifies.

68. The additive manufacturing method of claim 61, wherein protein strands of a protein layer are applied on top of a space between two neighboring protein strands of its preceding protein layer so as to form a honeycomb like arrangement of the protein strands, when said protein layers are viewed from a cross-sectional plan perpendicular to the plan of the protein layer.

69. The additive manufacturing method of claim 61, wherein a protein layer is applied such that the protein strands therein are essentially aligned with a previously applied protein layer.

70. The additive manufacturing method of claim 61, comprising applying pressure onto the layers, said pressure being applied in a direction perpendicular to the surface of the layers; and/or said pressure comprises vacuum pressure.

71. The additive manufacturing method of claim 61, wherein said thermal treatment is performed after applying at least part of the inter-strand sheaths material.
